(19) United States
(12) Patent Application Publication
(10) Pub. No.: US 2024/0070997 A1
(43) Pub. Date: Feb. 29, 2024

(54) WEARABLE DIRECTIONAL ANTENNA SIGNAL ANALYZER

(71) Applicant: BadVR, Inc., Los Angeles, CA (US)

(72) Inventors: Jad Meouchy, Los Angeles, CA (US); Suzanne Borders, Los Angeles, CA (US)

(21) Appl. No.: 17/893,887

(22) Filed: Aug. 23, 2022

(51) Int. Cl. G06T 19/00; G01S 3/04; G06F 3/01; H01Q 1/27; H01Q 9/04

(52) U.S. Cl. CPC G06T 19/006; G01S 3/043; G06F 3/011; H01Q 1/273; H01Q 9/0407

(57) ABSTRACT

Disclosed herein are systems and methods for identifying and characterizing radio transmissions for use with augmented reality (AR). Security personnel could wear discreet augmented reality sunglasses and chest-mounted flat (or patch) directional antennas to be alerted when specific radio frequency (RF) emitting devices enter the antenna's reception area. A user may also turn their body towards an individual person or place for the system to use the body orientation to do a directional signal analysis on the source of or potential threat in the field of view.

### BACKGROUND

One advantage of augmented and virtual reality systems is their ability to interact and enhance real-world experiences. Often referred to as “mixed reality” or the “metaverse” these real-world enhancements provide modern tools for measuring and sensing the real world and providing information to a user using various means such as visual or haptic feedback. For example, security personnel often need enhanced surveillance capabilities which may include the ability to scan an area by analyzing environmental elements such as radio or chemical emissions coming from a person or a place. Accordingly, there is a need for newer and easier-to-use surveillance systems.

### SUMMARY

Disclosed herein are systems and methods for identifying and characterizing radio transmissions for use with augmented reality (AR). Security personnel may wear discreet augmented reality glasses and chest or back-mounted flat (or patch) directional antennas to be alerted when specific radio frequency (RF) emitting devices enter the antenna's reception area. A user may also turn their body towards an individual person or place for the system to use the body orientation to facilitate a directional signal analysis on the potential threat in the field of view.

In one embodiment a body-worn patch antenna, a radio transceiver, an augmented reality headset or glasses, and a special software processing device connect the components together. The processing device may use body-worn inertial sensors and a headset to determine user body orientation and feed that information into the processor for 3D spatial RF signal analysis. This may then alert the user through subtle visual and/or audio cues on AR headsets of the radio frequencies that are being emitted in the direction of the patch antenna.

The ability to gather spatial RF data for three-dimensional objects, and the analysis of 3D datasets, using either established or new innovative computational methods, may be derived from a three-dimensional dataset. The dataset may include spectral information unique to certain types of RF emitters such as cell phones, RFID transponders, drones, industrial controls as well as convention RF spectrum identifiers.

In yet another embodiment includes an augmented reality device with a patch antenna disposed on an article of wearable clothing, a receiver coupled to the patch antenna and further coupled to a processing device, the AR display is coupled to the processing device and is operable to present an augmented reality (AR) image. The system may be controlled by a processor coded to receive a radio signal from the receiver, determine signal characteristics including signal strength and the radio signal's relative source direction, and display at least a portion of the signal characteristics as part of an AR visualization on the wearable display.

In yet other embodiments, a plurality of patch antennas may be employed and advanced direction finding process implemented to facilitate radio source location.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system

FIG. 2 illustrates a wearable antenna device.

FIG. 3 illustrates a representative AR view according to some embodiments.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “augmented reality” (AR) generally refers to an interactive experience of a real-world environment where the objects that reside in the real world are enhanced by computer-generated perceptual information, sometimes across multiple sensory modalities, such as visual, auditory, haptic, somatosensory and olfactory. AR may be defined as a system that incorporates three basic features: a combination of real and virtual worlds, real-time interaction, and 3D registration of virtual and real objects.

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

The term “virtual machine” or “VM” generally refers to a self-contained operating environment that behaves as if it is a separate computer even though it is part of a separate computer or may be virtualized using resources form multiple computers.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device.

### Client Server Processing

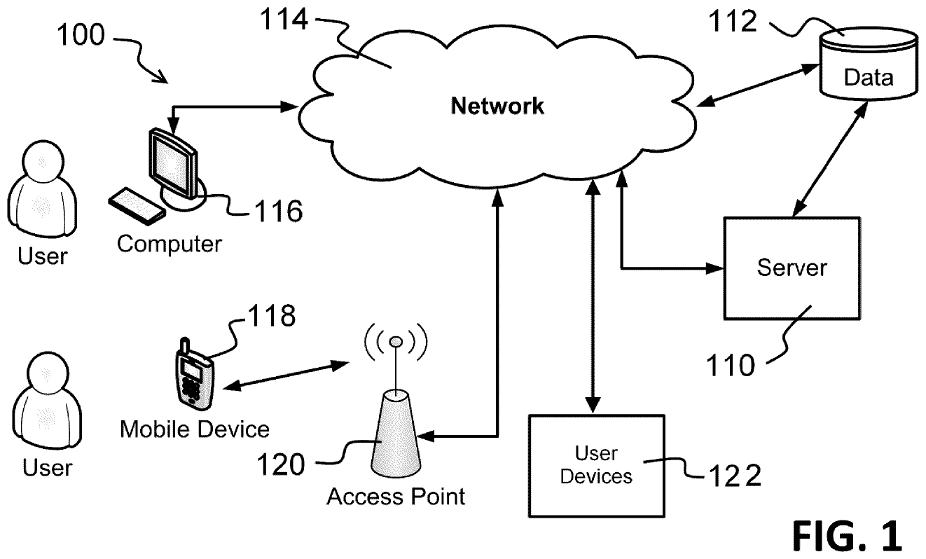

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively, the user may access the server 110 through the network 114 by using a smart device such as a telephone or PDA 118. The smart device 118 may connect to the server 110 through an access point 120 coupled to the network 114. The mobile device 118 includes a sound capture device such as a microphone. Other user devices 122 may also be coupled to the network in certain embodiments. These may include virtual reality (VR) and augmented reality (AR) headsets and visualization devices.

Conventionally, client server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a “Wi-Fi” or Bluetooth receiver, or software-defined radio system (SDR). Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

### Wearable Antenna

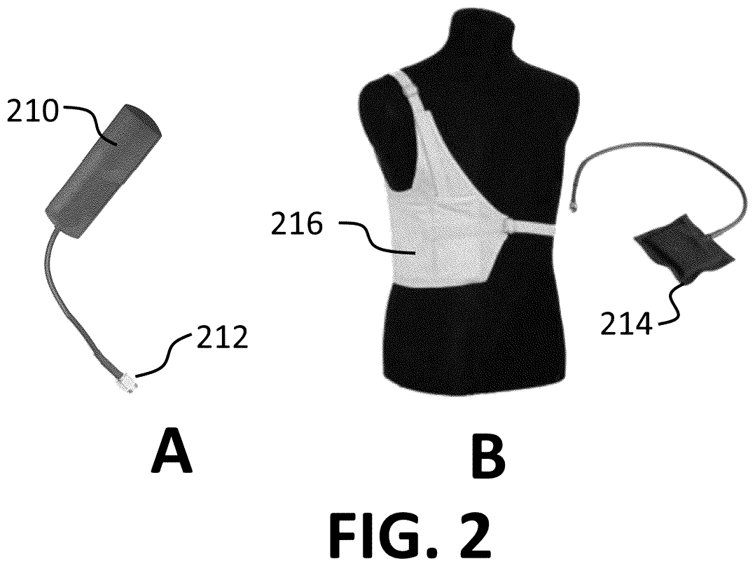

FIG. 2 illustrates a wearable antenna device. FIG. 2A depicts a commercially available patch antenna with an attached connector 212. The antenna design shown is a patch antenna most applicable to conventional Wi-Fi communications bands. While not limited to any particular frequency, certain frequency ranges such as, 800 mhz, 2-2.4 ghz, 5 ghz are applicable for directional cellular. Additionally, 4G and 5G data bands may be effectuated in certain embodiments. Moreover, emergency frequencies such as 457 khz (for avalanche and mountain rescue operations), 406 MHz for emergency personnel indicating radio beacons (EPIRB), and the like, may be effectuated with the proper antenna and receiver. However, this application should not be read a limiting in any way as different antennas may easily be employed to effectuate more embodiments.

The patch antenna 210 may be secure in a pouch or other enclosure 214 for fitting to a body harness 216 and connected to a receiver which may also be in the body harness 216. Certain embodiments may use the human body as a directional antenna by blocking RF in certain direction. For example, and without limitation, the wearer's body may minimize the transmission of RF if it has to pass through the body, whereas RF that does not pass through the body will provide a stronger signal. Accordingly, the position of the patch antenna may be ineffective in certain embodiments if not properly positioned.

To minimize any possible errors, the body harness 216 and the pouch 214 may be constructed to position the patch antenna 210 in substantially a single, reproducible area on the wearer's body. For example, and without limitation, forward facing with the patch antenna 210 positioned near the center of the wearer's torso.

In operation the wearer may rotate their body, thus using it as a shield, to position the patch antenna where the detected RF signal is maximized. This help identify to a wearer a first approximation of the location of an RF signal source. In some embodiments calibration may be performed wherein values from a known emissions source are plotted as the wearer turns, thus creating a calibration table to allow for future location correction. In yet other embodiments, a “dip” in the received signal may provide for a more accurate position reading wherein the wearer identifies the point where the received signal is weakest. Then, turning around, an inertial measurement unit (IMU) may provide information of the relative position of an RF source.

IMUs sense roll, pitch, and yaw of a device. Higher degree of freedom IMUs are conventionally available as well such as TDK's nine-axis model MPU-9250 motion tracking device. This motion tracking device, and similar devices include a 3-axis gyroscope, a 3-axis accelerometer, and an onboard digital motion processor capable of processing complex motion algorithms. Embodiments may also include commercially available 3-axis digital compasses of magnetometers. By positioning the wearer to identify the weakest RF signal, the IMU may then track the motion of the wearer as the wearer turns towards the source. By providing tracking, using the IMU, proper visualization of the RF source may be effectuated.

The connector 212 couples to an RF receiver and, in some embodiments, a spectrum analyzer. Conventional spectrum analyzers may allow for programmable spectra scans to target a specific area of the RF spectrum. A processor (not shown) may control the receiver and/or spectrum analyzer to target a desired frequency or frequency range. The processor may receive commands from a user and perform the desired function with the signal received from the patch antenna. These functions may include continuously sensing for a pre-determined frequency or scanning across a predefined RF band for signals.

In another embodiment multiple patch antennas may be employed providing for multiple, simultaneous reception of an RF signal at different positions. For example, and without limitation a patch antenna may be placed on the front torso, back, and each arm of a wearer by attaching them to a vest in a pre-determined pattern thus creating a patch antenna array. Relative position information may be gleaned from the received signals at each patch antenna with the strongest reception presumably from the patch closest to the transmitter. Similarly, the weakest received signal my indicate a position opposed to the location of a transmitter using the wearer's body as an attenuator.

In addition to a static reception, yet other embodiments may be utilized to track motion of a transmitter. For example, and without limitation a pseudo-doppler technique with a phase-based direction-finding (DF) method that produces a bearing estimate on the received signal by measuring the doppler shift induced on the signal by sampling around the elements of a circular array. Commercially available receivers employ this doppler-shift method to track motion of a transmitter if the wearer of the patch antenna array is stationary. Moreover, if the wearer is moving, the change in received frequency will indicate if the wearer is moving closer to or further from the transmitter. Signal sampling from multiple transmitters provides a plurality of locations for different transmitters allowing for locations of all transmitters to be displayed on an AR device.

### Control

Control of a wearable RF detector may be effectuated using a mobile device such as a smart watch or cell phone running a control application. Embodiments may be controlled through an application running on the headset or other attached computing device. Embodiments may employ holographic user input like tapping on virtual buttons (using AR hand tracking). The mobile device may be coupled to the RF receiver or spectrum analyzer using conventional means such as cabling or Bluetooth. In yet other embodiments, controls such as buttons on a body harness may be employed.

The application may provide control the frequencies that are being collected, perform a more detailed, higher resolution scan of specific radio frequencies, signal analyze what frequencies and protocols are being emitted from the user, flag the detected signal or individual for follow up by others (flagging a security risk), and initiate an active security countermeasure on the individual such as an offensive wireless port scan or Bluetooth inquiry or radio jamming. Features such as radio jamming may require the addition of a transmitter.

Once identified, the signal may be characterized according to the desired result. For example, and without limitation, known signals such as those from cellular phones or industrial applications may be ignored while unknown RF signals may be identified for notification to the wearer or remote user. The control application may display metrics of the received RF signal, such as signal strength and approximate direction. Embodiments may include additional metrics such as:

Wi-fi security level, type of network, type of device, what devices the target device is communicating with, what network is the device connected to (4G, 5G, ATT, Verizon, etc.). If the target device is Bluetooth, then pairing metrics may also be identified.

### Visualization

Visualization may be effectuated on a mobile device. For example, and without limitation using a circular plot, or other similar display, to show direction. Using a camera on the mobile device allows for image enhancement using augmented reality.

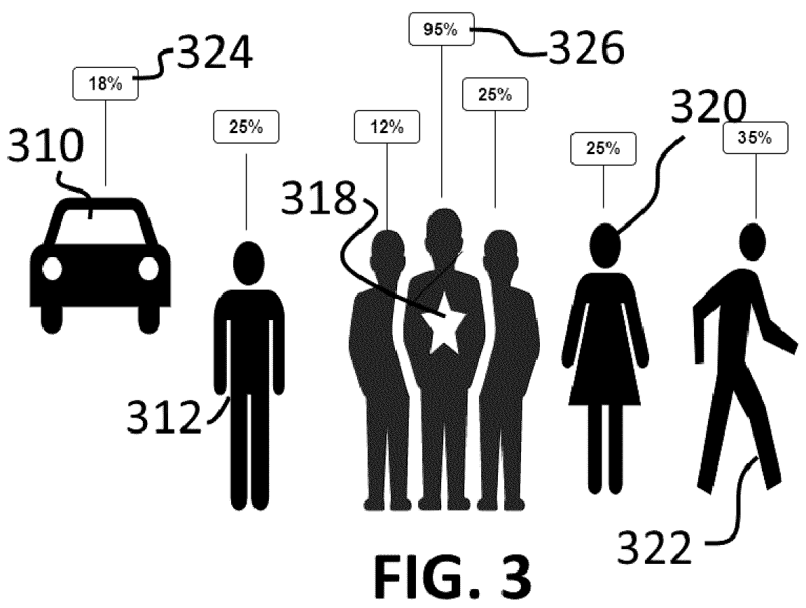

FIG. 3 illustrates a representative AR view according to some embodiments. In the representation shown, the automobile 310 and persons would be actual imagery from a camera. (The attached appendix includes a representative photograph.) The processor may then augment the real image to further include an indica of the input from the RF sense circuitry. In FIG. 3 an automobile 310 is shown indicating 324 a value of 18% whereas a person 318 is shown indicating 326 a value of 95%. Person 312, similarly to person 320, shows a signal level of 25%. Person 322 is in motion and the signal level for person 322 would change as the person moves.

While units are not shown in FIG. 3, the numbers represent signal strength of a particular spectra emanating from those identified entities. To effectuate an image similar to FIG. 3 a user may capture real-time video using a mobile device, and the processor enhances that real-time imagery with additional information regarding frequency scans.

Conventional AR video techniques and software development kits (SDKs) may provide tools to effectuate AR. AR software derives real world coordinates, independent of camera, and camera images. That process is called image registration, and may use different methods of computer vision, mostly related to video tracking. Augmented Reality Markup Language (ARML) is a data standard developed within the Open Geospatial Consortium (OGC), which consists of Extensible Markup Language (XML) grammar to describe the location and appearance of virtual objects in the scene, as well as ECMAScript bindings to allow dynamic access to properties of virtual objects. Certain embodiments may use JSON or PCAP development tools.

To enable rapid development of augmented reality applications, some software development applications such as Lens Studio from Snapchat and Spark AR from Meta were launched. Moreover, Software Development kits (SDKs) from Apple and Google have emerged. Thus, conventional AR tools are available to effectuate certain embodiments described herein.

### AR Headset Operation

Augmented reality visualization tools are commercially available for use in some embodiments. These may provide for a user's visualization using a device similar to reading or sunglasses. Various technologies are used in augmented reality rendering, including optical projection systems, monitors, handheld devices, and display systems, which are worn on the human body. Some embodiments may include elements of a virtual reality system to achieve certain results.

A head-mounted display (HMD) is a display device worn on the forehead, such as a harness or helmet-mount. HMDs place images of both the physical world and virtual objects over the user's field of view. Modern HMDs often employ sensors, such as IMUs, for six degrees of freedom monitoring that allow the system to align virtual information to the physical world and adjust accordingly with the user's head movements. HMDs can provide VR users with mobile and collaborative experiences. Specific providers, such as uSens and Gestigon, include gesture controls for full virtual immersion. While conventional HMDs are described herein, this disclosure should not be read as limiting in any way. For example, other forms of AR displays, such as retinal displays, contact lenses, and the like.

In some embodiments a head mounted display may be coupled to the processing device. This coupling may be with wire, or in some embodiments, wirelessly such as through Bluetooth. In operation, a user may move their body and position the patch to sense RF in a certain direction. An HMD might also capture real-time images through a camera. The processing device may then superimpose the sensed RF information in the user's field of view and create an image similar to that of FIG. 3.

Video see-through (VST) is one of the affordable techniques to deliver AR experiences. In VST, a camera captures a digital video image of the real world and transfers it to the graphics processor in real-time. Then the graphics processor combines the video image feed with computer-generated images (virtual content) and displays it on the screen. Optical see-through displays operate using optical elements (like half-silvered mirrors) that are half-transmissive and half reflective to combine real world and virtual elements. The mirror allows a sufficient amount of light from the real world to pass through making it possible to see the surroundings directly. Simultaneously, computer-generated images are projected on the mirror through a display component placed overhead or on the side, which creates a perception of the combined world

### Advantages

As more devices are coupled using wireless technology, the demand for monitoring the wireless spectrum will increase. Some possible applications include looking for jamming devices or other sources of radio interference. The widespread use of drones and drone technology may require identification of a drone's control signal, or location of the drone if it is beyond visible sight. For example, and without limitation, a wearer may direction find on an unidentified RF signal and have the source of that signal displayed on an AR device thus providing an RF scan of the area. If the RF source is moving or approaching, the processor may provide a visual indication to the wearer of the motion.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. An augmented reality device including:
a patch antenna disposed on an article of wearable clothing;
a receiver coupled to the patch antenna and further coupled to a processing device;
a wearable display coupled to the processing device, said display operable to present an augmented reality (AR) image;
a non-transitory memory coupled to the processor, said memory including instructions directing the processor to:
receive a radio signal from the receiver;
determine signal characteristics including signal strength and the radio signal's relative source direction, and
display at least a portion of the signal characteristics as part of an AR visualization on the wearable display.

2. The device of claim 1 wherein the instructions further include:
associate a signal characteristic with an image in the wearable display and wherein the signal characteristics are displayed with an image.

3. The device of claim 1 including a plurality of antennas, each antenna disposed to receive an RF signal from a different direction.

4. The device of claim 1 wherein the at least one antenna is a patch antenna.

5. The device of claim 1 wherein the wearable clothing is a body harness.

6. An augmented reality device including:
at least one antenna disposed on an article of wearable clothing;
a receiver coupled to the at least one antenna and further coupled to a processing device;
a wearable display coupled to the processing device, said display operable to present an augmented reality (AR) image;
a non-transitory memory coupled to the processor, said memory including instructions directing the processor to:
receive a radio signal;
determine signal characteristics, and
display at least a portion of the signal characteristics as part of an AR visualization on the wearable display.

7. The device of claim 6 wherein the signal characteristics include relative position information of the radio signal's source.

8. The device of claim 6 wherein the instructions further include:
associate a signal characteristic with an image in the wearable display and wherein the signal characteristics are displayed with an image.

9. The device of claim 6 wherein the at least one antenna is part of an antenna array.

10. The device of claim 6 wherein the antenna is a patch antenna.

11. The device of claim 6 wherein the signal characteristics includes a relative direction of a radio signal source, and the augmented reality visualization associates a real image with the radio signal source.

12. One or more memory devices encoded with non-transitory processor instructions directing a processing device to perform a method including:
receiving radio signal information;
analyzing the radio signal information;
converting a portion of the radio signal information to an augmented reality image information, and
displaying the image information in an AR display.

13. The devices of claim 12 wherein the AR display is an AR headset.

14. The devices of claim 12 wherein the radio signal information includes a relative direction of a radio signal source, and the augmented reality image information associates a real image with the radio signal source.

15. The devices of claim 12 wherein the augmented reality image information includes an indicia of the radio signal's strength.
